(19) United States
(12) Patent Application Publication
(10) Pub. No.: US 2008/0191970 A1
(43) Pub. Date: Aug. 14, 2008

(54) METHOD OF DRIVING PLASMA DISPLAY APPARATUS

(75) Inventor: Byung Joon RHEE, Yongin-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/673,080

(22) Filed: Feb. 9, 2007

(51) Int. Cl. G09G 3/28

(52) U.S. Cl. 345/60

(57) ABSTRACT

A method of driving a plasma display apparatus is disclosed. In the method, a first reset pulse including a rising pulse and a falling pulse is applied to a scan electrode during a reset period of a first subfield of a plurality of subfields. A second reset pulse including a rising pulse and a falling pulse is applied to the scan electrode during a reset period of a turn-on subfield next to a turn-off subfield in the remaining subfields except the first subfield. A third reset pulse including a falling pulse is applied to the scan electrode during a reset period of another subfield except the subfields during which the first reset pulse and the second reset pulse are applied.

### BACKGROUND

1. Field

This document relates to a plasma display apparatus, and more particularly, to a method of driving a plasma display apparatus.

2. Description of the Related Art

Out of display apparatuses, a plasma display apparatus includes a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

A rising pulse applied to a scan electrode during a reset period is a high-voltage pulse such that the quantity of light generated by a discharge generated by the rising pulse increases relatively.

Thus, a luminance (i.e., a black level luminance) in an OFF state of all the discharge cells of the plasma display panel relatively increases. This results in a degradation of a contrast characteristic and the generation of image retention.

Accordingly, a method to apply the rising pulse in only one subfield of one frame was proposed such that a portion of the contrast characteristic was improved. However, an erroneous discharge may be generated at a specific gray level.

### SUMMARY

In one aspect, a method of driving a plasma display apparatus displaying an image with one frame being time-divided into a plurality of subfields comprises applying a first reset pulse including a rising pulse and a falling pulse to a scan electrode during a reset period of a first subfield of the plurality of subfields, applying a second reset pulse including a rising pulse and a falling pulse to the scan electrode during a reset period of a turn-on subfield next to a turn-off subfield in the remaining subfields except the first subfield, and applying a third reset pulse including a falling pulse to the scan electrode during a reset period of another subfield except the subfields during which the first reset pulse and the second reset pulse are applied.

The method may further comprise applying a first pre-reset pulse to the scan electrode prior to the reset period of the first subfield, and applying a second pre-reset pulse of a polarity opposite a polarity of the first pre-reset pulse to a sustain electrode correspondingly to the first pre-reset pulse.

The first subfield may be a subfield of the lowest gray level weight.

The subfield during which the second reset pulse is applied may range from a fifth subfield to subfields succeeding the fifth subfield in the plurality of subfields arranged in an increasing order of gray level weight.

A peak voltage of the rising pulse of the second reset pulse may be lower than a peak voltage of the rising pulse of the first reset pulse.

The first pre-reset pulse may be a negative polarity.

The first pre-reset pulse may be a falling pulse with gradually falling voltages.

The falling pulse of the third reset pulse may fall from a predetermined bias voltage.

The predetermined bias voltage may be substantially equal to a sustain voltage.

In another aspect, a method of driving a plasma display apparatus displaying an image during a plurality of frames comprises applying a first reset pulse including a rising pulse and a falling pulse to a scan electrode during a reset period of a first frame of the plurality of frames, and applying a second reset pulse including a falling pulse to the scan electrode during all reset periods of a second frame that succeeds the first frame.

The falling pulse of the second reset pulse may fall from a predetermined bias voltage.

The predetermined bias voltage may be substantially equal to a sustain voltage.

The method may further comprise applying a third reset pulse and a fourth reset pulse to the scan electrode during a reset period of a first subfield of a third frame that succeeds the second frame.

The third reset pulse and the fourth reset pulse may each comprise a rising pulse.

A peak voltage of the third reset pulse may be higher than a peak voltage of the fourth reset pulse.

A difference between the peak voltage of the third reset pulse and the peak voltage of the fourth reset pulse may be equal to or less than 100V.

The third reset pulse may comprise a square wave, and the fourth reset pulse may comprise a rising pulse.

A time period during which the square wave of the third reset pulse is applied may be shorter than a time period during which the rising pulse of the fourth reset pulse is applied.

In still another aspect, a method of driving a plasma display apparatus displaying an image during a plurality of frames comprises applying a first reset pulse including a rising pulse and a falling pulse to a scan electrode during a reset period of a first frame of the plurality of frames, applying a second reset pulse including at least two rising pulses to the scan electrode during all reset periods of a second frame that succeeds the first frame, wherein a time period during which one rising pulse of the second reset pulse is applied is shorter than a time period during which the rising pulse of the first reset pulse is applied.

The number of rising pulses of the second reset pulse may range from 2 to 3 for each subfield.

The method may further comprise applying a third reset pulse and a fourth reset pulse to the scan electrode during a reset period of a first subfield of a third frame that succeeds the second frame.

The third reset pulse and the fourth reset pulse may each comprise a rising pulse.

A peak voltage of the third reset pulse may be higher than a peak voltage of the fourth reset pulse.

A difference between the peak voltage of the third reset pulse and the peak voltage of the fourth reset pulse may be equal to or less than 100V.

The third reset pulse may comprise a square wave, and the fourth reset pulse may comprise a rising pulse.

A time period during which the square wave of the third reset pulse is applied may be shorter than a time period during which the rising pulse of the fourth reset pulse is applied.

In yet still another aspect, a method of driving a plasma display apparatus displaying an image during a plurality of frames comprises applying a first reset pulse including a rising pulse and a falling pulse to a scan electrode during a reset period of a first frame of the plurality of frames, and applying a second reset pulse including a falling pulse instead of the first reset pulse to the scan electrode during a reset period of at least one subfield of a second frame that succeeds the first frame, wherein the number of second reset pulses increases each time there is a variation from one frame to another frame.

The number of second reset pulses may increase by one each time there is a variation from one frame to another frame.

The second reset pulse may be first applied in a subfield of the highest gray level weight.

The first reset pulse may be applied in one or more subfields of one frame.

The falling pulse of the second reset pulse may fall from a predetermined bias voltage.

The predetermined bias voltage may be substantially equal to a sustain voltage.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention.

FIG. 1 illustrates a plasma display panel according to one embodiment;

FIG. 2 illustrates a method for representing a gray level of an image in the plasma display panel according to one embodiment;

FIG. 3 illustrates a plasma display apparatus according to one embodiment;

FIG. 4 illustrates a method of driving a plasma display apparatus according to a first embodiment;

FIG. 5 illustrates a method of driving a plasma display apparatus according to a second embodiment;

FIG. 6 is a diagram for comparing areas A and B of FIG. 5;

FIG. 7 is a diagram for explaining in detail a first subfield in a method of driving a plasma display apparatus according to a third embodiment;

FIG. 8 illustrates a method of driving a plasma display apparatus according to a fourth embodiment;

FIG. 9 is a diagram for explaining in detail an area A of FIG. 8;

FIG. 10 illustrates a method of driving a plasma display apparatus according to a fifth embodiment;

FIG. 11 is a diagram for explaining in detail an area B of FIG. 10;

FIG. 12 illustrates a method of driving a plasma display apparatus according to a sixth embodiment;

FIG. 13 illustrates a method of driving a plasma display apparatus according to a seventh embodiment;

FIG. 14 is a diagram for explaining in detail an area A of FIG. 13; and

FIG. 15 is a diagram for explaining in detail a driving waveform depending on the method of driving the plasma display apparatus according to the seventh embodiment.

### DETAILED DESCRIPTION OF PREFERRED EMBODIMENTS

Reference will now be made in detail embodiments of the invention examples of which are illustrated in the accompanying drawings.

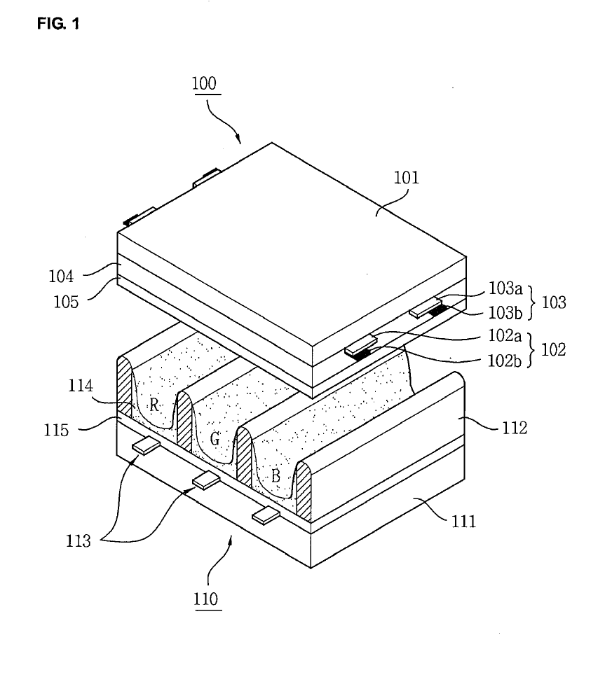

FIG. 1 illustrates a plasma display panel according to one embodiment.

Referring to FIG. 1, the plasma display panel includes a front panel 100 and a rear panel 110 which are coupled in parallel to oppose to each other at a given distance therebetween. The front panel 100 includes a front substrate 101 which is a display surface. The rear panel 110 includes a rear substrate 111 constituting a rear surface. A plurality of scan electrodes 102 and a plurality of sustain electrodes 103 are formed in pairs on the front substrate 101, on which an image is displayed, to form a plurality of maintenance electrode pairs. A plurality of address electrodes 113 are arranged on the rear substrate 111 to intersect the plurality of maintenance electrode pairs.

The scan electrode 102 and the sustain electrode 103 each include transparent electrodes 102a and 103a made of a transparent indium-tin-oxide (ITO) material and bus electrodes 102b and 103b made of a metal material. The scan electrode 102 and the sustain electrode 103 generate a mutual discharge therebetween in one discharge cell and maintain light-emissions of discharge cells.

The scan electrode 102 and the sustain electrode 103 are covered with one or more upper dielectric layers 104 for limiting a discharge current and providing insulation between the maintenance electrode pairs. A protective layer 105 with a deposit of magnesium oxide (MgO) is formed on an upper surface of the upper dielectric layer 104 to facilitate discharge conditions.

A plurality of stripe-type or well-type barrier ribs 112 are formed in parallel to each other on the rear substrate 111 of the rear panel 110 to form a plurality of discharge spaces, i.e., a plurality of discharge cells. The plurality of address electrodes 113 for performing an address discharge to generate vacuum ultraviolet rays are arranged in parallel to the barrier ribs 112.

An upper surface of the rear substrate 111 is coated with red (R), green (G) and blue (B) phosphors 114 for emitting visible light for an image display during the generation of the sustain discharge. A lower dielectric layer 115 is formed between the address electrodes 113 and the phosphors 114 to protect the address electrodes 113.

In the plasma display panel of the above-described structure, the plurality of discharge cells are formed in a matrix form. A driver including a driving circuit for applying a predetermined pulse to the discharge cells is attached to the plasma display panel, thereby driving the plasma display panel.

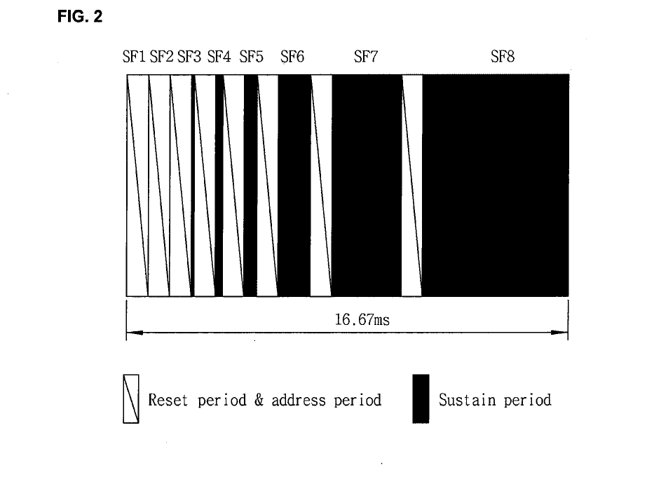

FIG. 2 illustrates a method for representing a gray level of an image in the plasma display panel according to one embodiment.

Referring to FIG. 2, the plasma display panel is driven with a frame being divided into a plurality of subfields having a different number of emission times. Each subfield is subdivided into a reset period for uniformly generating a discharge, an address period for selecting a discharge cell, and a sustain period for representing a gray level in accordance with the number of discharges.

For example, if an image with 256-gray level is to be displayed, a frame period (for example, 16.67 ms) corresponding to 1/60 sec is divided into eight subfields SF1 to SF8. Each of the eight subfields SF1 to SF8 is subdivided into a reset period, an address period, and a sustain period.

A duration of the reset period in a subfield is equal to a duration of the reset periods in the other subfields. A duration of the address period in a subfield is equal to a duration of the address periods in the other subfields. However, a duration of the sustain period of each subfield may be different from one another, and the number of sustain pulses assigned during the sustain period of each subfield may be different from one another. For example, the sustain period increases in a ratio of 2ⁿ (where, n=0, 1, 2, 3, 4, 5, 6, 7) in each of the subfields. Although the above description has been made with respect to a case where one frame includes 8 subfields, it is not limited thereto. One frame may include 10 to 12 subfields.

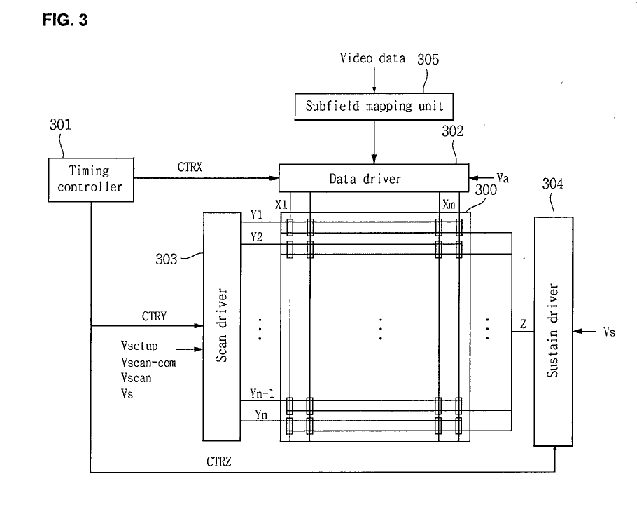

FIG. 3 illustrates a plasma display apparatus according to one embodiment.

Referring to FIG. 3, the plasma display apparatus according to one embodiment includes a plasma display panel 300 including a scan electrode, a timing controller 301, a data driver 302, a scan driver 303, a sustain driver 304, and a subfield mapping unit 305.

The timing controller 301 receives a vertical/horizontal synchronization signal and a predetermined clock signal. The controller 121 generates timing control signals CTRX, CTRY and CTRZ for controlling each of the drivers 302, 303 and 304, and applies the timing control signals CTRX, CTRY and CTRZ to the corresponding drivers 302, 303 and 304, respectively.

Accordingly, the timing controller 301 controls operations of the drivers 302, 303 and 304. Further, the timing controller 301 controls the scan driver 303 to apply a reset pulse including only a falling pulse to the scan electrodes Y1 to Yn during a portion of a plurality of subfields. This results in the prevention of an erroneous discharge caused by an unstable discharge.

The data driver 122 applies a data pulse, which is sampled and latched in response to the timing control signal CTRX received from the timing controller 301, to the address electrodes X1 to Xm.

Under the control of the timing controller 301, the scan driver 303 controls the reset pulse applied to the scan electrodes Y1 to Yn during a reset period.

Under the control of the timing controller 301, the scan driver 303 consecutively applies scan pulses with a scan voltage −Vy to the scan electrodes Y1 to Yn during an address period.

Under the control of the timing controller 301, the sustain driver 304 applies a bias voltage of a sustain voltage Vs to the sustain electrodes z during a set-down period of the reset period and the address period. The scan driver 303 and the sustain driver 304 alternatively operate during a sustain period to apply a sustain pulse to the scan electrodes Y1 to Yn and the sustain electrodes Z.

The last sustain discharge ends in one subfield, and then the sustain driver 304 may apply an erase pulse to the sustain electrodes Z.

The subfield mapping unit 305 maps video data, which is processed through a predetermined imaging process, for each subfield, and then outputs the mapped video data.

For example, the subfield mapping unit 305 maps video data for each subfield, after performing a motion process, an average power level (APL) process, an half-tone correction process, and the like, on video data input from an external signal processor (not illustrated), for example, a video signal controller (VSC) chip (not illustrated). Then, the subfield mapping unit 305 produces the mapped video data and outputs it.

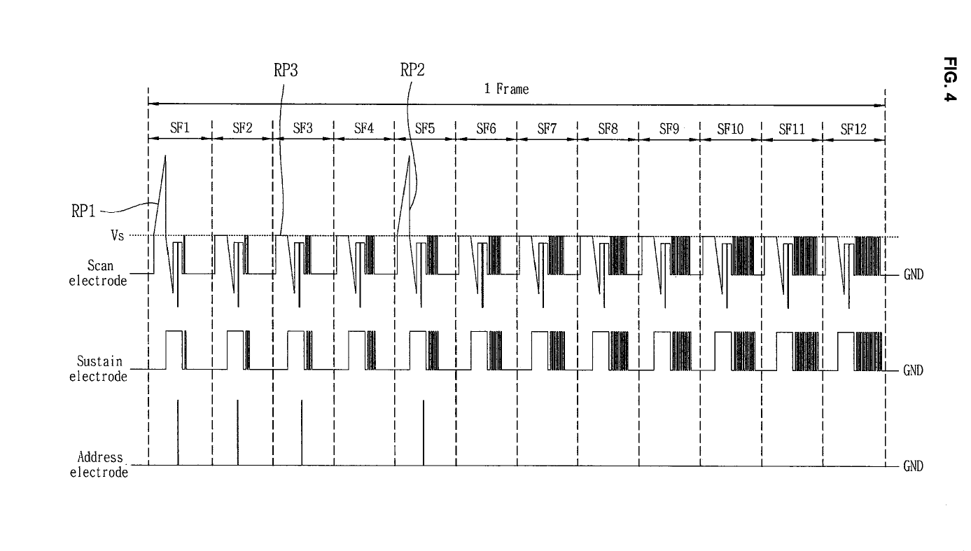

FIG. 4 illustrates a method of driving a plasma display apparatus according to a first embodiment.

Referring to FIG. 4, the driving method of the plasma display apparatus according to the first embodiment displays an image during a plurality of frames, and each frame is divided into a plurality of subfields having a different number of emission times. Each frame may be divided into 10 or 12 subfields having a different number of emission times.

The driving method according to the first embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the first embodiment includes applying a first reset pulse RP1 including a rising pulse and a falling pulse to the scan electrode during a reset period of a subfield (for example, a first subfield SF1) of the lowest gray level weight, and applying a third reset pulse RP3 including only a falling pulse to the scan electrode in a subfield except the first subfield SF1.

The falling pulse of third reset pulse RP3 is maintained at a sustain voltage Vs being a bias voltage, and then falls from the sustain voltage Vs. A contrast characteristic is improved by reducing the number of applications of a rising pulse with a high voltage.

In a case where a rising pulse is applied one time during one frame, an erroneous discharge may occur at a specific gray level. To prevent the erroneous discharge, a second reset pulse RP2 including a rising pulse and a falling pulse is applied to the scan electrode during a reset period of a turn-on subfield next to a turn-off subfield.

For example, in a case where all subfields of one frame are turned on, one subfield of subfields with a relative low gray level weight may be unstable. However, since all the subfields succeeding the unstable subfield have been turned on, a stable discharge occurs due to discharges of many sustain pulses.

However, as illustrated in FIG. 4, if three subfields SF1-SF3 in subfields SF1-SF5 of a relative low gray level weight are turned on and the fifth subfield SF5 is turned on, the number of sustain pulses generated in the subfields succeeding the turn-on subfield SF3 is not sufficient. This results in the generation of an erroneous discharge in the turn-on subfield SF5.

The generation of an erroneous discharge in the turn-on subfield SF5 is prevented by applying the second reset pulse RP2 including the rising pulse and the falling pulse in the turn-on subfield SF5 next to the unstable subfield SF3.

Although the subfields SF1, SF2, SF3 and SF5 as a turn-on subfield were optionally set in FIG. 4 for the easy explanation, the first embodiment is not limited thereto.

For example, it is assumed that the first subfield SF1 is turned on and the fifth subfield SF5 is turned on again, the third reset pulse RP3 including only the falling pulse is applied during reset periods of the second to fourth subfields SF2-SF4. Therefore, it is a great likelihood of the generation of an erroneous discharge in the fifth subfield SF5.

Accordingly, the second reset pulse RP2 including the rising pulse and the falling pulse is applied in the fifth subfield SF5 such that the generation of the erroneous discharge is prevented in the fifth subfield SF5.

In the first embodiment, the subfields during which the third reset pulse RP3 is applied may be a low gray level subfield. The low gray level subfield may range from the first to fourth subfields SF1-SF4 in the subfields SF1-SF12 of one frame arranged in an increasing order of gray level weight.

The subfields during which the second reset pulse RP2 is applied may range from the fifth to twelfth subfields SF5-SF12 in the subfields SF1-SF12 of one frame arranged in an increasing order of gray level weight.

If the first reset pulse RP1 including the rising pulse and the falling pulse is applied in the subfield SF1 of the lowest gray level and the third reset pulse RP3 including only the falling pulse is applied in the first to fourth subfields SF1-SF4 in the subfields SF1-SF12 of one frame arranged in an increasing order of gray level weight, it is a great likelihood of the generation of the erroneous discharge due to the unstable discharge. Therefore, the second reset pulse RP2 is applied in the fifth to twelfth subfields SF5-SF12 in the subfields SF1-SF12 of one frame arranged in an increasing order of gray level weight.

Accordingly, the number of rising pulses applied during one frame is reduced considerably such that a contrast characteristic is improved and an erroneous discharge at a specific gray level is prevented.

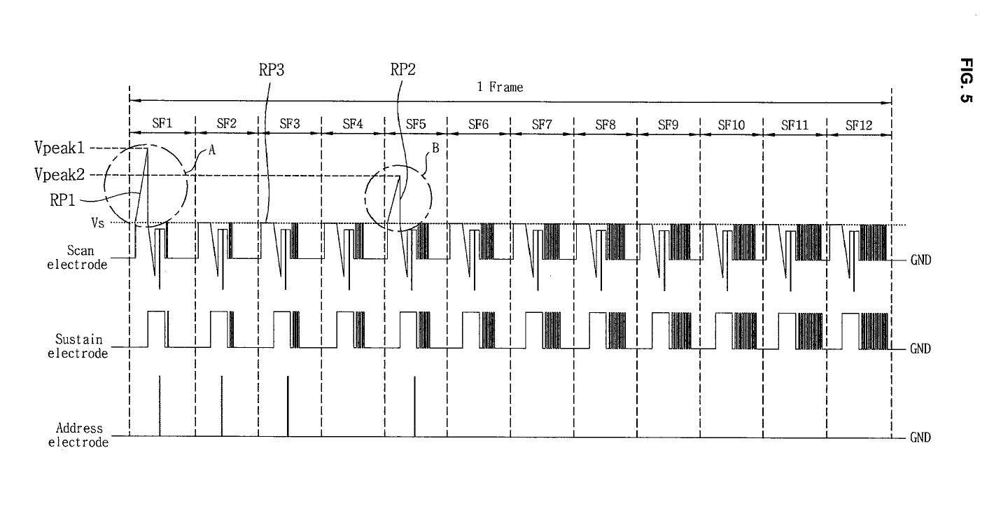

FIG. 5 illustrates a method of driving a plasma display apparatus according to a second embodiment.

As illustrated in FIG. 5, a first reset pulse RP1 and a second reset pulse RP2 are applied during a reset period of a subfield SF1 with the lowest gray level weight and a reset period of a turn-on subfield SF5 next to a turn-off subfield SF4 in a plurality of subfields SF1-SF12, respectively so that a peak voltage Vpeak1 of a rising pulse of the first reset pulse RP1 is higher than a peak voltage Vpeak2 of a rising pulse of the second reset pulse RP2.

In the first embodiment illustrated in FIG. 4, to prevent the generation of the erroneous discharge, a peak voltage of the rising pulse of the first reset pulse RP1 applied during the reset period of the lowest gray level subfield SF1 is equal to a peak voltage of the rising pulse of the second reset pulse RP2 applied during the reset period of the fifth subfield SF5. However, unlike the first embodiment, in FIG. 5, the generation of a flicker is prevented by applying the second reset pulse RP2 having the peak voltage vpeak2, that is lower than the peak voltage Vpeak1 of the first reset pulse RP1 applied during the reset period of the lowest gray level subfield SF1, during the reset period of the turn-on subfield SF5 next to the turn-off subfield SF4.

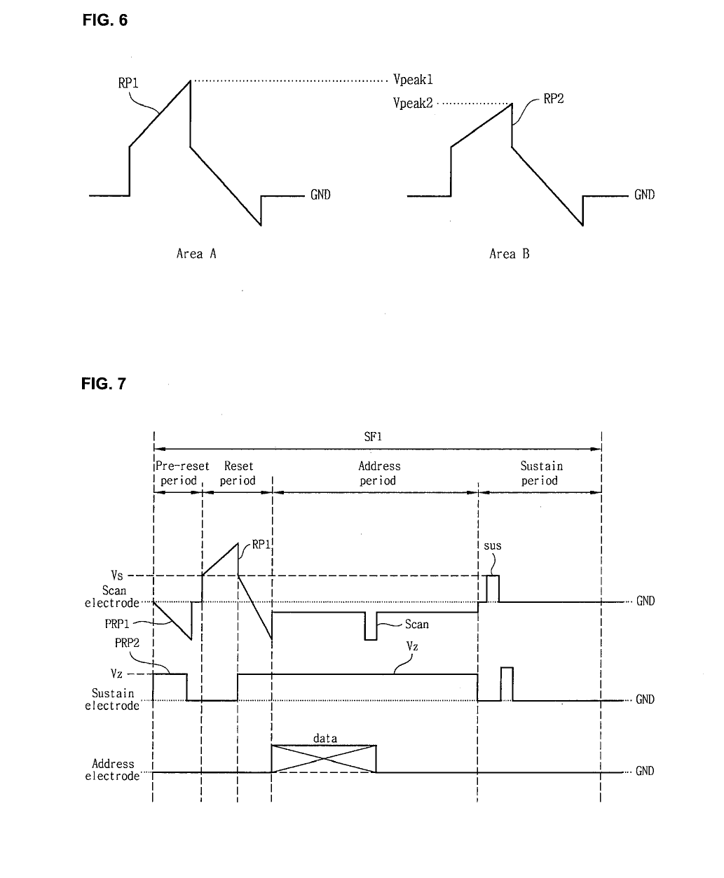

FIG. 6 is a diagram for comparing areas A and B of FIG. 5. As illustrated in FIG. 6, the peak voltage Vpeak1 of the first reset pulse RP1 applied in the area A (i.e., the lowest gray level subfield SF1) is higher than the peak voltage vpeak2 of the second reset pulse RP2 applied in the area B (i.e., the turn-on subfield SF5 next to the turn-off subfield SF4).

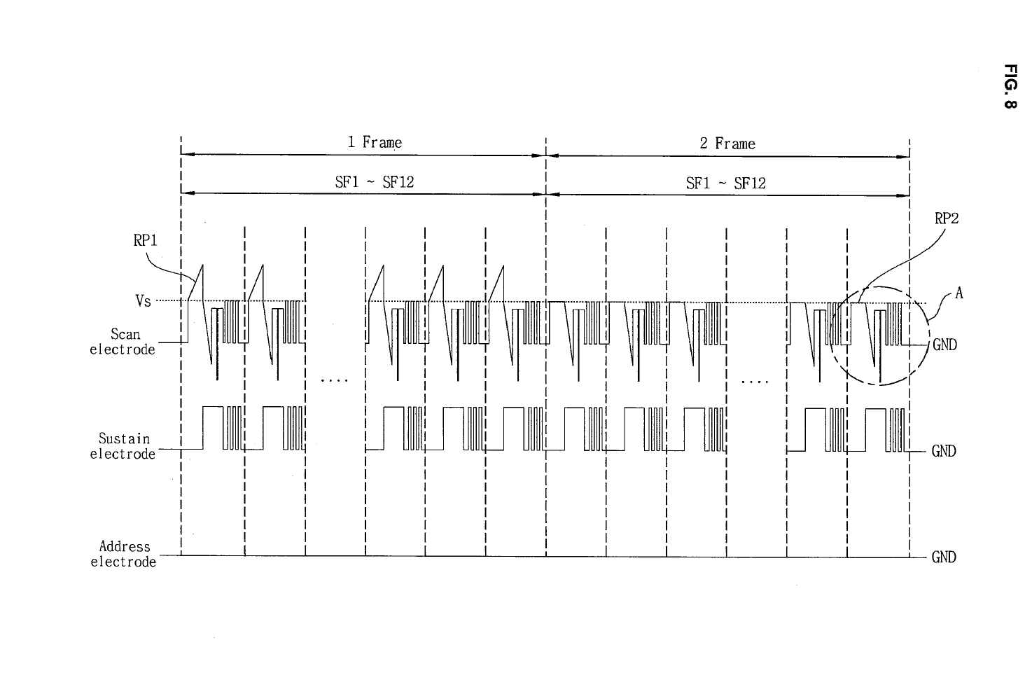

FIG. 7 is a diagram for explaining in detail a first subfield in a method of driving a plasma display apparatus according to a third embodiment.

As illustrated in FIG. 7, before applying a first reset pulse RP1 having a rising pulse and a falling pulse to the scan electrode during a reset period of a first subfield SF1 as illustrated in FIGS. 4 and 5, a first pre-reset pulse PRP1 is applied to the scan electrode and a second pre-reset pulse PRP2 of a polarity opposite a polarity of the first pre-reset pulse PRP1 is applied to the sustain electrode correspondingly to the first pre-reset pulse PRP1.

The first pre-reset pulse PRP1 is a negative polarity, and may be a falling pulse gradually falling from a ground level voltage GND. The second pre-reset pulse PRP2 is a positive polarity, and may be a square wave.

As above, since the first and second pre-reset pulses PRP1 and PRP2 are applied prior to the reset period of the first subfield SF1, a peak voltage of the rising pulse of the first reset pulse RP1 applied during the reset period of the first subfield SF1 is lowered. This results in a reduction in a black level luminance in a reset process.

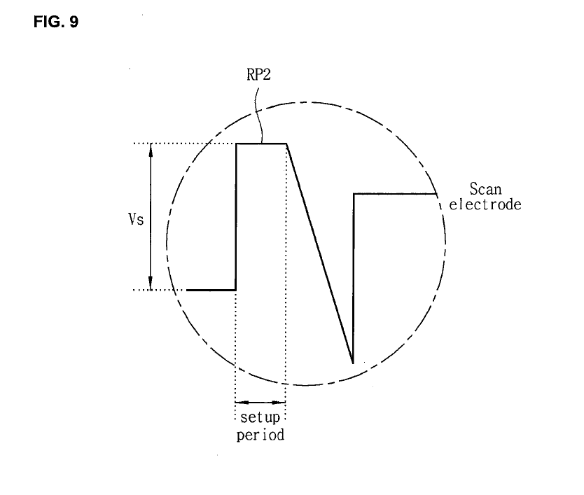

FIG. 8 illustrates a method of driving a plasma display apparatus according to a fourth embodiment.

As illustrated in FIG. 8, the driving method of the plasma display apparatus according to the fourth embodiment displays an image during a plurality of frames, and each frame is divided into a plurality of subfields having a different number of emission times. Each frame may be divided into 10 or 12 subfields having a different number of emission times.

The driving method according to the fourth embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the fourth embodiment applies a first reset pulse RP1 including a rising pulse and a falling pulse to the scan electrode during a reset period of each of subfields SF1-SF12 of a first frame.

Then, in a case where a second frame succeeding the first frame is an OFF-cell, a second reset pulse RP2 including only a falling pulse is applied to the scan electrode during a reset period of each of subfields SF1-SF12 of the second frame.

For example, if the first frame corresponding to a portion of a display surface (not illustrated) of the plasma display panel is an ON-cell, the first reset pulse RP1 is applied in the twelve subfields SF1-SF12 of the first frame, and the second frame is the OFF-cell in the whole panel, a window pattern displayed on the portion of the panel display surface appears as a image retention pattern.

Accordingly, when there is a variation from the first frame being the ON-cell to the second frame being the OFF-cell, the second reset pulse RP2 including only the falling pulse is applied in all the subfields SF1-SF12 of the second frame.

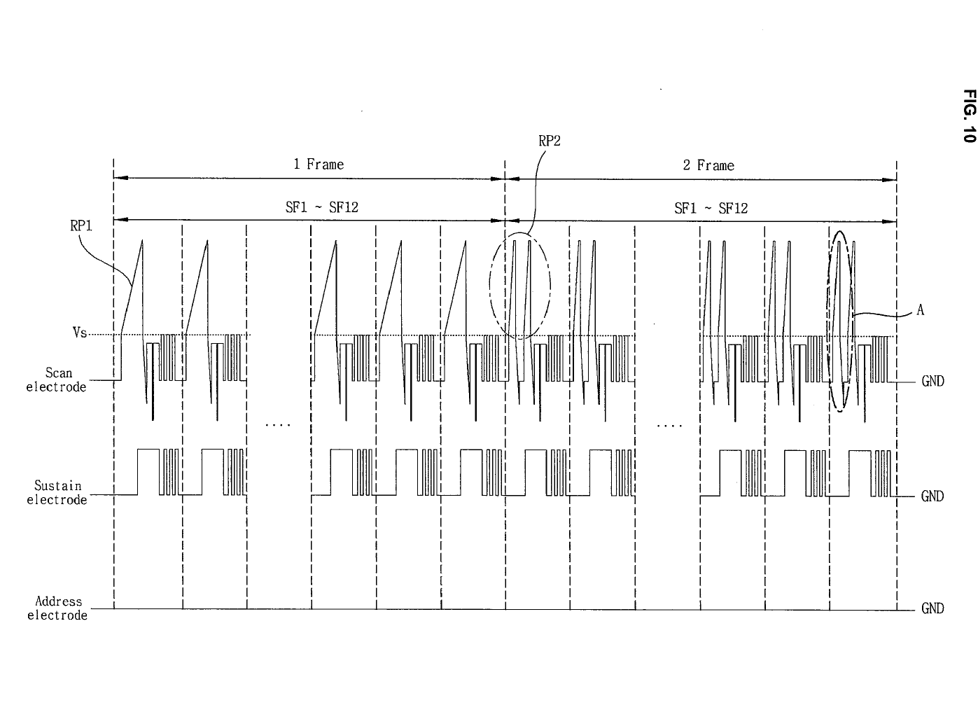

FIG. 9 is a diagram for explaining in detail an area A of FIG. 8. As illustrated in FIG. 9, the second reset pulse RP2 applied in all the subfields SF1-SF12 of the second frame includes only the falling pulse.

The falling pulse is maintained at a sustain voltage Vs being a bias voltage, and then gradually falls from the sustain voltage Vs.

As above, since the second reset pulse RP2 applied in the second frame has a luminance of about 0 cd/m² per pulse as compared with the first reset pulse RP1 having a luminance of about 0.1 cd/m² or more per pulse, the application of the second reset pulse RP2 lowers an image retention level when there is the variation from the first frame being the ON-cell to the second frame being the OFF-cell and a contrast characteristic is improved.

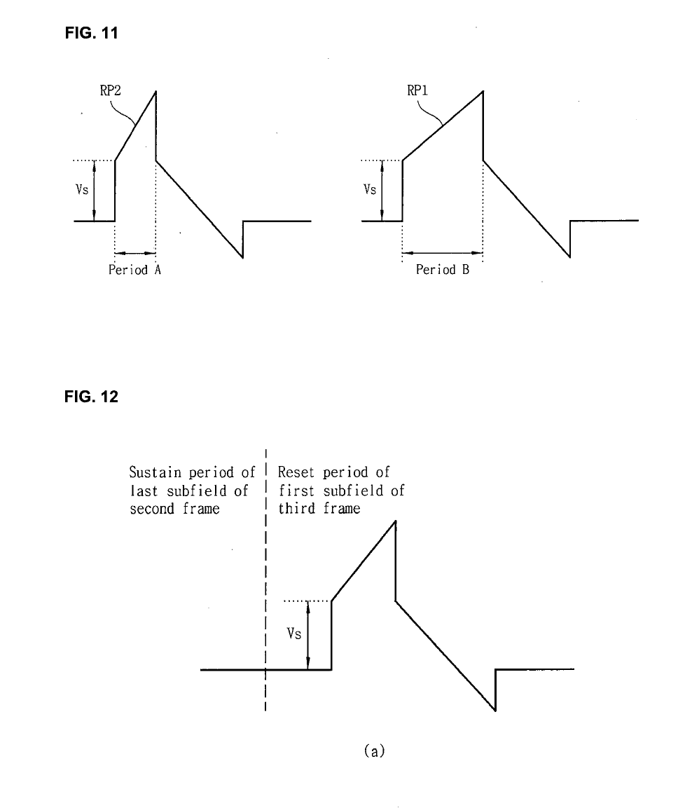

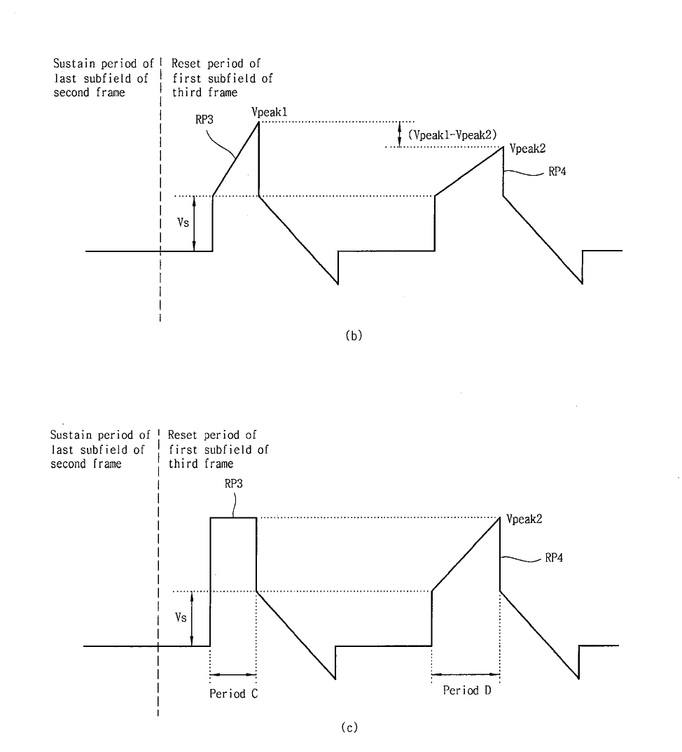

FIG. 10 illustrates a method of driving a plasma display apparatus according to a fifth embodiment, and FIG. 11 is a diagram for explaining in detail an area B of FIG. 10.

As illustrated in FIG. 10, the driving method according to the fifth embodiment applies a first reset pulse RP1 including a rising pulse and a falling pulse to the scan electrode during a reset period of each of subfields SF1-SF12 of a first frame.

Then, in a case where a second frame succeeding the first frame is an OFF-cell, a second reset pulse RP2 including at least two rising pulses is applied to the scan electrode during reset periods of all subfields SF1-SF12 of the second frame.

As illustrated in FIG. 11, a time period A in the subfields SF1-SF12 of the second frame during which one rising pulse of the second reset pulse RP2 is applied is shorter than a time period B in the subfields SF1-SF12 of the first frame during which the rising pulse of the first reset pulse RP1 is applied.

The number of rising pulses applied in all the subfields SF1-SF12 of the second frame may range from 1 to 3 for each subfield of the second frame.

Since the rising pulses applied in the subfields of the first frame has a luminance of about 0.1 cd/m² per pulse, a flicker may occur due to the luminance deviation when an ON-cell and an OFF-cell are alternately varied to each other such that a contrast characteristic may worsen.

Accordingly, a weak discharge occurs several times by applying the second reset pulse RP2 including the 2 or 3 rising pulses having a luminance of about 0.04 cd/m² per pulse. As a result, several weak discharges lower a level of dark image retention as compared with one strong discharge, and the generation of the flicker due to the luminance deviation is prevented.

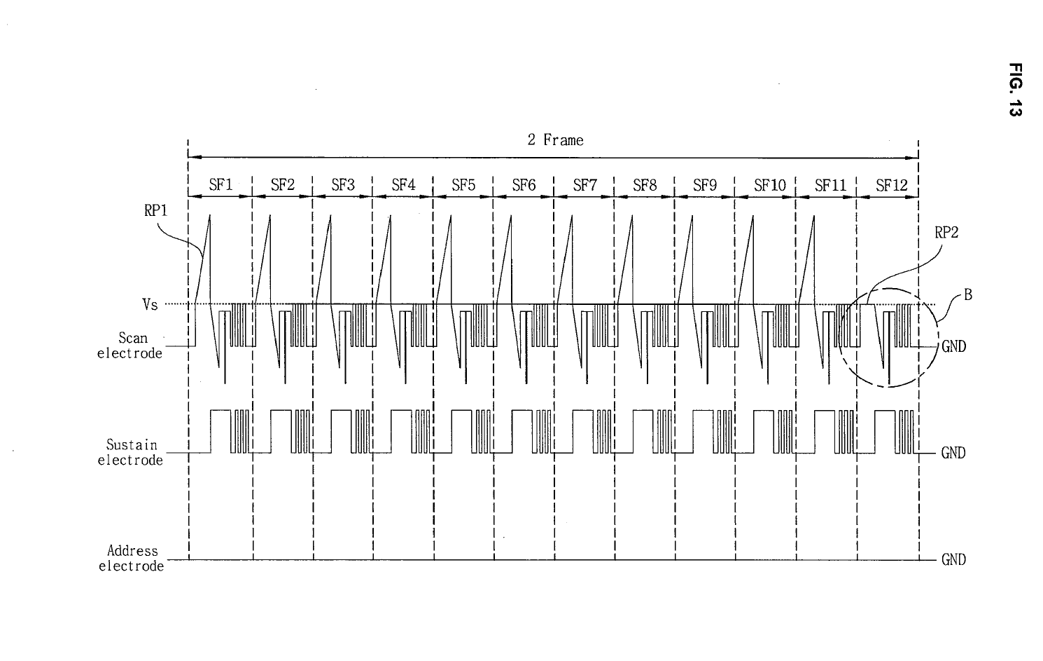

FIG. 12 illustrates a method of driving a plasma display apparatus according to a sixth embodiment.

(a) of FIG. 12 illustrates a related art reset pulse applied during a last subfield of a second frame and a first subfield of a third frame next to the second frame.

As illustrated in (a) of FIG. 12, after applying a second reset pulse illustrated in FIGS. 8 and 10 in the second frame, one reset pulse is applied during a reset period of the first subfield of the third frame next to the second frame. In this case, it is difficult to vary a discharge when there is a variation from the second frame being an OFF-cell to the third frame being an ON-cell.

(b) of FIG. 12 illustrates a reset pulse according to the sixth embodiment applied during a last subfield of a second frame and a first subfield of a third frame next to the second frame. As illustrated in (b) of FIG. 12, a third reset pulse RP3 and a fourth reset pulse RP4 are applied in the first subfield of the third frame.

The third reset pulse RP3 and the fourth reset pulse RP4 each include a rising pulse.

A first peak voltage Vpeak1 of the third reset pulse RP3 is higher than a second peak voltage Vpeak2 of the fourth reset pulse RP4.

A difference (Vpeak1−Vpeak2) between the first peak voltage Vpeak1 and the second peak voltage Vpeak2 may be equal to or less than 100V.

As above, since the third reset pulse RP3 that is higher than the fourth reset pulse RP4 by 100V or less is applied, the unstableness of discharge is solved when there is a variation from the second frame being an OFF-cell to the third frame being an ON-cell.

The third reset pulse RP3 having a different form from the third reset pulse RP3 illustrated in (b) of FIG. 12 may be applied. This will be described with reference to (c) of FIG. 12.

As illustrated in (c) of FIG. 12, the third reset pulse RP3 applied in the first subfield of the third frame includes a square wave.

A voltage of the square wave is equal to the second peak voltage Vpeak2 of the fourth reset pulse RP4. A time period C during which the square wave of the third reset pulse RP3 is applied is shorter than a time period D during which the rising pulse of the fourth reset pulse RP4 is applied.

As above, since the third reset pulse RP3 is applied during the time period C, that is shorter than the time period D during which the fourth reset pulse RP4 is applied, the unstableness of discharge is solved when there is a variation from the second frame being an OFF-cell to the third frame being an ON-cell.

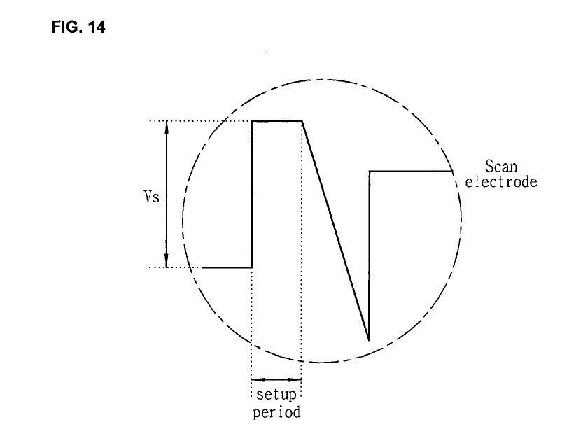

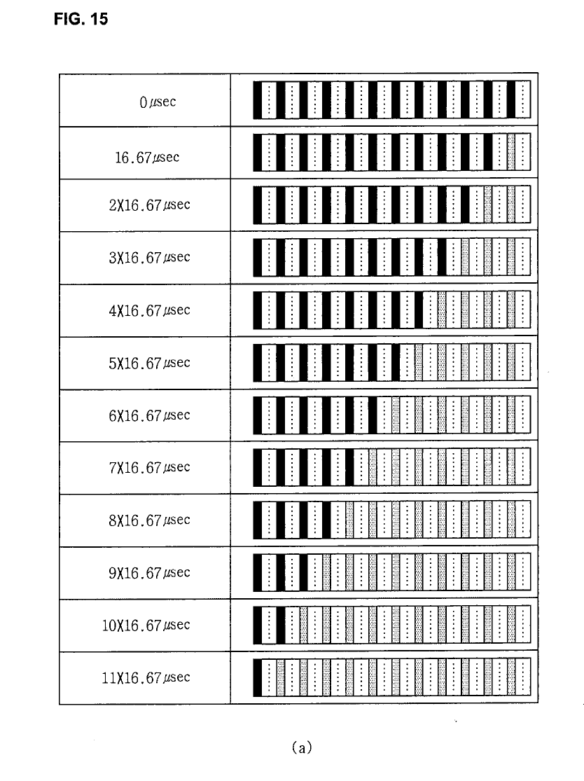

FIG. 13 illustrates a method of driving a plasma display apparatus according to a seventh embodiment, and FIG. 14 is a diagram for explaining in detail an area A of FIG. 13.

As illustrated in FIG. 13, the driving method of the plasma display apparatus according to the seventh embodiment displays an image during a plurality of frames, and each frame is divided into a plurality of subfields having a different number of emission times. Each frame may be divided into 10 or 12 subfields having a different number of emission times.

The driving method according to the seventh embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the seventh embodiment applies a first reset pulse RP1 including a rising pulse and a falling pulse to the scan electrode during a reset period of each of subfields SF1-SF12 of a first frame.

Then, in a case where a second frame succeeding the first frame is an OFF-cell, a second reset pulse RP2 including only a falling pulse instead of the first reset pulse RP1 is applied to the scan electrode during a reset period of at least one subfield (for example, a twelfth subfield SF12 in FIG. 13) of the second frame.

For example, if the first frame is an ON-cell, the 12 first reset pulses RP1 are applied in the 12 subfields of the first frame, respectively, and the second frame is an OFF-cell, an image retention pattern appears in the second frame.

When there is a variation from the first frame being the ON-cell to the second frame being the OFF-cell, the second reset pulse RP2 starts to be applied from the last subfield SF12 of the second frame.

In other words, if the second frame includes 12 subfields, the first reset pulse RP1 is applied in 11 subfields of the second frame and the second reset pulse RP2 is applied in the remaining one subfield.

Subsequently, if a third frame succeeding the second frame is an OFF-cell, the first reset pulse RP1 is applied in 10 subfields of the third frame and the second reset pulse RP2 is applied in the remaining two subfields.

If subfields succeeding the third frame are in a state of an OFF-cell, the number of second reset pulses may increase by one each time there is a variation from one frame to another frame.

As illustrated in FIG. 14, the second reset pulse RP2 applied instead of the first reset pulse RP1 in at least one subfield of the second frame includes only the falling pulse.

The falling pulse is maintained at a sustain voltage Vs being a bias voltage, and gradually falls from the sustain voltage Vs.

since the second reset pulse RP2 including only the falling pulse has a luminance of about 0 cd/m² per pulse as compared with the first reset pulse RP1 having a luminance of about 0.1 cd/r² or more per pulse, the application of the second reset pulse RP2 lowers an image retention level when there is the variation from the first frame being the ON-cell to the second frame being the OFF-cell.

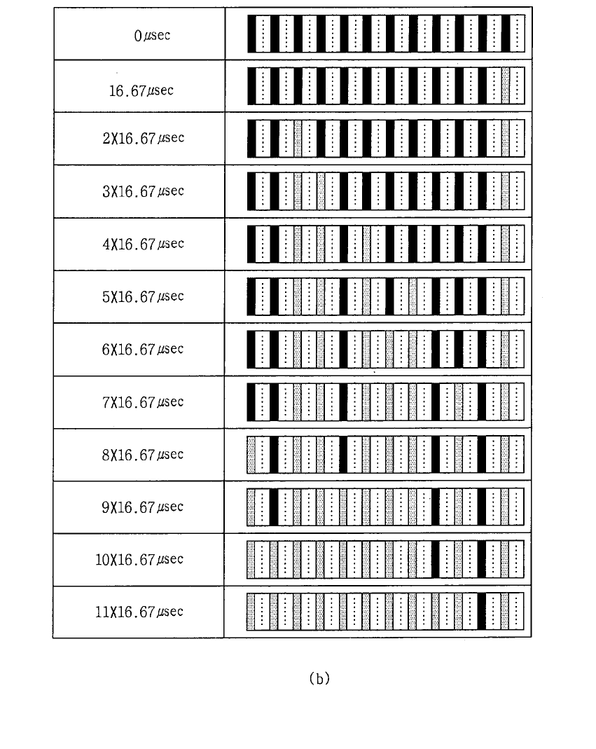

FIG. 15 is a diagram for explaining in detail a driving waveform depending on the method of driving the plasma display apparatus according to the seventh embodiment.

As illustrated in (a) of FIG. 15, the second reset pulse RP2 applied in at least one subfield of the second frame may be applied in reverse order from a subfield of the highest gray level weight.

For example, if one frame includes 12 subfields and a subsequent frame of a first frame being an ON-cell is an OFF-cell, the second reset pulse RP2 is applied during a reset period of a last subfield SF12 of the subsequent frame.

If a subsequent frame of a frame being an OFF-cell is an OFF-cell, the second reset pulse RP2 is applied during a reset period of a last subfield SF12 of the subsequent frame and an eleventh subfield SF11 in reverse order from the last subfield SF12. Accordingly, the increasing number of frames being an OFF-cell is proportional to the increasing number of second reset pulses RP2.

On the other hand, if a subsequent frame of a frame being an OFF-cell is varied to an ON-cell, the first reset pulse RP1 is applied in all subfields of the subsequent frame.

Although frames being an OFF-cell are repeated constantly such that the number of first reset pulses RP1 is reduced and the number of second reset pulses RP2 increases when there is a variation from one frame to another frame, at least one first reset pulses RP1 is applied during one frame.

For example, in a case where second to fifteenth frames succeeding a first frame being an ON-cell are constantly an OFF-cell, the first reset pulses RP1 is applied in one subfield of an eleventh frame and the second reset pulses RP2 is applied in the remaining 11 subfields of the eleventh frame.

Subsequently, in a case where a twelfth frame next to the eleventh frame is an OFF-cell, the second reset pulses RP2 is not applied in all subfields of the twelfth frame. In the same way as the eleventh frame, the first reset pulses RP1 is applied in one subfield of the twelfth frame and the second reset pulses RP2 is applied in the remaining 11 subfields of the twelfth frame.

As above, since the second reset pulse RP2 is applied in reverse order from a subfield of the highest gray level weight, the generation of an erroneous discharge is prevented and time required in removing dark image retention is reduced.

The second reset pulse RP2 may be applied in another way. This will be described with reference to (b) of FIG. 15.

As illustrated in (b) of FIG. 15, the second reset pulse RP2 applied in at least one subfield of the second frame may be applied irrespective of the order of subfield when there is a variation from one frame to another frame.

For example, if one frame includes 12 subfields and a subsequent frame of a first frame being an ON-cell is an OFF-cell, the second reset pulse RP2 may be applied during a reset period of a last subfield SF12 of the subsequent frame, and the second reset pulse RP2 may be applied during a reset period of a tenth subfield SF10 of the subsequent frame.

Subsequently, if a subsequent frame of a frame being an OFF-cell is an OFF-cell, the second reset pulse RP2 may be applied during a reset period of a third subfield SF3 of the subsequent frame. Accordingly, the increasing number of frames being an OFF-cell is proportional to the increasing number of second reset pulses RP2.

On the other hands, when there is a variation from a frame being an OFF-cell to a frame being an ON-cell, the first reset pulse RP1 is applied in all subfields of the frame being an ON-cell

Accordingly, the generation of an erroneous discharge is prevented and time required in removing dark image retention is reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A method of driving a plasma display apparatus displaying an image with one frame being time-divided into a plurality of subfields, the method comprising:
applying a first reset pulse including a rising pulse and a falling pulse to a scan electrode during a reset period of a first subfield of the plurality of subfields;
applying a second reset pulse including a rising pulse and a falling pulse to the scan electrode during a reset period of a turn-on subfield next to a turn-off subfield in the remaining subfields except the first subfield; and
applying a third reset pulse including a falling pulse to the scan electrode during a reset period of another subfield except the subfields during which the first reset pulse and the second reset pulse are applied.

2. The method of claim 1, further comprising applying a first pre-reset pulse to the scan electrode prior to the reset period of the first subfield, and applying a second pre-reset pulse of a polarity opposite a polarity of the first pre-reset pulse to a sustain electrode correspondingly to the first pre-reset pulse.

3. The method of claim 2, wherein the first subfield is a subfield of the lowest gray level weight.

4. The method of claim 2, wherein the subfield during which the second reset pulse is applied ranges from a fifth subfield to subfields succeeding the fifth subfield in the plurality of subfields arranged in an increasing order of gray level weight.

5. The method of claim 2, wherein a peak voltage of the rising pulse of the second reset pulse is lower than a peak voltage of the rising pulse of the first reset pulse.

6. The method of claim 2, wherein the first pre-reset pulse is a negative polarity.

7. The method of claim 6, wherein the first pre-reset pulse is a falling pulse with gradually falling voltages.

8. The method of claim 2, wherein the falling pulse of the third reset pulse falls from a predetermined bias voltage.

9. The method of claim 8, wherein the predetermined bias voltage is substantially equal to a sustain voltage.

10. A method of driving a plasma display apparatus displaying an image during a plurality of frames, the method comprising:
applying a first reset pulse including a rising pulse and a falling pulse to a scan electrode during a reset period of a first frame of the plurality of frames; and
applying a second reset pulse including a falling pulse to the scan electrode during all reset periods of a second frame that succeeds the first frame.

11. The method of claim 10, wherein the falling pulse of the second reset pulse falls from a predetermined bias voltage.

12. The method of claim 11, wherein the predetermined bias voltage is substantially equal to a sustain voltage.

13. The method of claim 10, further comprising applying a third reset pulse and a fourth reset pulse to the scan electrode during a reset period of a first subfield of a third frame that succeeds the second frame.

14. The method of claim 13, wherein the third reset pulse and the fourth reset pulse each comprise a rising pulse.

15. The method of claim 14, wherein a peak voltage of the third reset pulse is higher than a peak voltage of the fourth reset pulse.

16. The method of claim 15, wherein a difference between the peak voltage of the third reset pulse and the peak voltage of the fourth reset pulse is equal to or less than 100V.

17. The method of claim 13, wherein the third reset pulse comprises a square wave, and the fourth reset pulse comprises a rising pulse.

18. The method of claim 17, wherein a time period during which the square wave of the third reset pulse is applied is shorter than a time period during which the rising pulse of the fourth reset pulse is applied.

19. A method of driving a plasma display apparatus displaying an image during a plurality of frames, the method comprising:
applying a first reset pulse including a rising pulse and a falling pulse to a scan electrode during a reset period of a first frame of the plurality of frames; and
applying a second reset pulse including at least two rising pulses to the scan electrode during all reset periods of a second frame that succeeds the first frame,
wherein a time period during which one rising pulse of the second reset pulse is applied is shorter than a time period during which the rising pulse of the first reset pulse is applied.

20. The method of claim 19, wherein the number of rising pulses of the second reset pulse ranges from 2 to 3 for each subfield.

21. The method of claim 19, further comprising applying a third reset pulse and a fourth reset pulse to the scan electrode during a reset period of a first subfield of a third frame that succeeds the second frame.

22. The method of claim 21, wherein the third reset pulse and the fourth reset pulse each comprise a rising pulse.

23. The method of claim 22, wherein a peak voltage of the third reset pulse is higher than a peak voltage of the fourth reset pulse.

24. The method of claim 23, wherein a difference between the peak voltage of the third reset pulse and the peak voltage of the fourth reset pulse is equal to or less than 100V.

25. The method of claim 21, wherein the third reset pulse comprises a square wave, and the fourth reset pulse comprises a rising pulse.

26. The method of claim 25, wherein a time period during which the square wave of the third reset pulse is applied is shorter than a time period during which the rising pulse of the fourth reset pulse is applied.

27. A method of driving a plasma display apparatus displaying an image during a plurality of frames, the method comprising:
applying a first reset pulse including a rising pulse and a falling pulse to a scan electrode during a reset period of a first frame of the plurality of frames; and
applying a second reset pulse including a falling pulse instead of the first reset pulse to the scan electrode during a reset period of at least one subfield of a second frame that succeeds the first frame,
wherein the number of second reset pulses increases each time there is a variation from one frame to another frame.

28. The method of claim 27, wherein the number of second reset pulses increases by one each time there is a variation from one frame to another frame.

29. The method of claim 28, wherein the second reset pulse is first applied in a subfield of the highest gray level weight.

30. The method of claim 29, wherein the first reset pulse is applied in one or more subfields of one frame.

31. The method of claim 27, wherein the falling pulse of the second reset pulse falls from a predetermined bias voltage.

32. The method of claim 31, wherein the predetermined bias voltage is substantially equal to a sustain voltage.
